(19) United States
(12) Patent Application Publication
(10) Pub. No.: US 2021/0107699 A1
(43) Pub. Date: Apr. 15, 2021

(54) Segmented Storage Container

(71) Applicant: Double Down, LLC, Waterford, MI (US)

(72) Inventors: Ryan Raphael Atto, Bloomfield Hills, MI (US); Joseph Fouad Basmaji, Waterford, MI (US)

(73) Assignee: Double Down, LLC, Dearborn, MI (US)

(21) Appl. No.: 17/060,653

(22) Filed: Oct. 1, 2020

Related U.S. Application Data
(60) Provisional application No. 62/913,949, filed on Oct. 11, 2019.

(51) Int. Cl. B65D 21/02; B65D 85/12; B65D 85/10; B65D 41/16; B65D 55/16; B29D 22/00; A61J 1/14; A61J 1/03

(52) U.S. Cl. CPC B65D 21/0228; B65D 85/12; B65D 85/10; A61J 1/03; B65D 55/16; B29D 22/003; A61J 1/1425; B65D 41/16

(57) ABSTRACT

Consumers of tobacco products or pharmaceuticals are known to carry such on their person in containers to protect the product in their pocket or purse and so that the product is available as needed. A container in which two containers are selectively coupled together is disclosed. In some embodiments, a first, larger container contains fresh product while the second, smaller container contains partially-consumed product. Or in some cases, the smaller container is used to hand off a small amount of the product (tobacco or the pharmaceutical) to another person, e.g., a caregiver attending to a patient. The approaches disclosed herein to couple the two containers include: snap fit, magnetic coupling, and a sliding groove/ridge fit.

### FIELD OF INVENTION

The present disclosure is about storage containers for transporting items such as food, pharmaceuticals, or tobacco.

### BACKGROUND

It is known in the prior art to carry consumables, such as prescription medications, cigarettes, or small foods, such as candy away from home, in one's pocket or purse. In FIG. 1, a prior art container 8 holds 4-5 cigarettes or one cigar, possibly two slender cigars. Container 8 allows the user to carry the container in their pocket while protecting the tobacco product from being bent or broken. Additionally, the cigar or cigarettes are protected from the elements, such as rain, entering the container. The odor that might off gas from the tobacco product is also largely prevented from leaving the container. In other situations, a smaller version of such a container, can be used to transport medications that one might wish to take from home to take a midday dose or while on a trip. Patients suffering from angina are advised to carry nitroglycerine with them whenever they leave their home and put a pill under their tongue whenever they experience chest pain.

It is common for cigar smokers to smoke only a portion of cigar at a time, extinguishing it and storing it for later use. A cigarette smoker might be interrupted early in the process of smoking. As cigarettes are expensive, smokers are known to extinguish the cigarette and save it for later use. One could store the partially consumed tobacco product with the fresh product within container 8 of FIG. 1. However, the ashes and smoky smell of the partially consumed product may taint the flavor of the fresh products or transfer some ashes to the filter of the fresh cigarettes. One option would be to carry two such cases to separate fresh and used product.

Another use of container 8 might be to hold medications. There may be instances where a caregiver of a person suffering from angina might wish to transfer some of the nitroglycerine to a temporary caregiver without relinquishing their entire supply of the medication. That is, there could be instances where having a second container with a smaller amount of the medication to hand off to the temporary caregiver is desired. Managing two separate containers can become unwieldy and/or subject to misplacing the one of them, particularly the smaller of the two. Furthermore, if they are identical, then one must take time to identify the container that one is transferring to another person.

### SUMMARY

To overcome at least one problem in the prior art, a segmented container is disclosed that has: a first container having a first tubular body, a first bottom coupled to a first end of the first tubular body, and a first removable cap selectively couplable to a second end of the first tubular body; and a second container having a first tubular body, a second bottom coupled to a first end of the second tubular body, and a second removable cap selectively couplable to a second end of the second tubular body. The first removable cap snap fits onto the second end of the first tubular body. The second removable cap snap fits onto the second end of the second tubular body. The first bottom of the first container selectively couples to the second bottom of the second container via a snap-fit connection.

The first removable cap is substantially disk shaped with a circumferential groove. The first tubular body has an inwardly extending circumferential tab near the second end. The circumferential groove of the first removable cap engages with the inwardly extending circumferential tab when the first removable cap is coupled to the first tubular body.

The second removable cap is substantially disk shaped with a circumferential groove. The second tubular body has an inwardly extending circumferential feature near the second end. The circumferential groove of the second removable cap engages with the inwardly extending circumferential tab when the second removable cap is coupled to the second tubular body.

A first strap coupled between the first removable cap and the first tubular body. A second strap coupled between the second removable cap and the second tubular body.

The first strap, the first removable cap, the first bottom, and the first tubular body are molded in a first unitary piece. The second strap, the second removable cap, the second bottom, and the second tubular body are molded in a second unitary piece.

The first bottom has a first circumferential extension extending away from the first tubular body. The first circumferential extension has a circumferential groove defined therein with an opening of the groove facing inwardly. The second bottom has a second circumferential extension extending away from the second tubular body. The second circumferential extension has a tab extending radially outwardly. The tab engages with the circumferential groove when the first bottom is snap fit with the second bottom.

The first bottom, the first circular extension, and the first tubular body are molded in a first unitary piece. The tab, the second bottom, and the second tubular body are molded in a second unitary piece.

The first bottom has a circumferential groove molded into an outer surface of the first bottom. The second bottom has a circumferential tab extending out of an outer surface of the second bottom. The circumferential tab engages with the circumferential groove when the first bottom is snap fit with the second bottom.

The first tubular body has the shape of one of a cylinder and a frustum. The second tubular body has the shape of one of a cylinder and a frustum.

The first removable cap is substantially disk shaped with a circumferential groove. The first tubular body has an outwardly extending circumferential tab near the second end. The circumferential groove of the first removable cap engages with the outwardly extending circumferential tab when the first removable cap is coupled to the first tubular body.

Also disclosed is a method to manufacture a segmented container, including: injection molding a first container having: a first tubular body, a first bottom coupled to a first end of the first tubular body, a first cap, and a first strap coupling the first cap to the first tubular body; and injection molding a second container having: a second tubular body, a second bottom coupled to a first end of the second tubular body, a second cap, and a second strap coupling the second cap to the second tubular body. The first cap selectively snap fits onto a second end of the first tubular body. The second cap selectively snap fits onto a second end of the second tubular body. The first bottom selectively snap fits to the second bottom.

The first removable cap is substantially disk shaped and has a first circumferential groove defined therein. The first tubular body has a first circumferential tab near an end of the first tubular body. The first circumferential tab engages with the first circumferential groove when the first removable cap is coupled to the first tubular body. The second removable cap is substantially disk shaped and has a second circumferential groove defined therein. The second tubular body has a second circumferential tab near an end of the second tubular body. The second circumferential tab engages with the second circumferential groove when the second removable cap is coupled to the second tubular body.

The first bottom has a first circumferential extension with an inwardly facing groove defined therein. The first circumferential extension extends away from the first tubular body. The second bottom has a second circumferential extension that that extends away from the second tubular body. The second circumferential extension has a circumferential tab that mates with the inwardly facing groove when the first container is coupled to the second container.

The first bottom has a circumferential groove molded into an outer surface of the first bottom. The second bottom has a circumferential tab extending out of an outer surface of the second bottom. The circumferential tab engages with the circumferential groove when the first bottom is snap fit with the second bottom.

An opening of the circumferential groove is oriented toward the center.

In other embodiments, a segmented container includes: a first container having a first tubular body, a first bottom coupled to a first end of the first tubular body, and a first cap selectively couplable to a second end of the first tubular body; and a second container having a first tubular body, a second bottom coupled to a first end of the second tubular body, and a second cap selectively couplable to a second end of the second tubular body. The first bottom has a first extension extending away from the first tubular body with a circumferential groove defined therein. The second bottom has a second extension extending away from the second tubular body. The second extension has a circumferential tab. The circumferential tab mates with the circumferential groove when the first bottom is snap fit with the second bottom.

The segmented container also has a first strap coupled between the first tubular body and the first cap and a second strap coupled between the second tubular body and the second cap.

The first tubular body, the first removable cap, the first bottom, and the first cap are molded in a first unitary piece. The second tubular body, the second removable cap, the second bottom, and the second cap are molded in a second unitary piece.

The first tubular body is one of: a cylinder and a frustum; and the second tubular body is one of: a cylinder and a frustum.

An alternative segmented container includes: a first container having a first tubular body, a first bottom coupled to a first end of the first tubular body, and a first removable cap selectively couplable to a second end of the first tubular body; a second container having a first tubular body, a second bottom coupled to a first end of the second tubular body, and a second removable cap selectively couplable to a second end of the second tubular body; a magnet coupled to the first bottom; and a ferromagnetic piece coupled to the second bottom.

The first removable cap selectively snap fits onto the second end of the first tubular body. The second removable cap selectively snap fits onto the second end of the second tubular body.

The first removable cap is substantially disk shaped with a circumferential groove. The first tubular body has an outwardly extending circumferential tab near the second end. The outwardly extending circumferential tab mates with the circumferential groove when the first removable cap is coupled to the first tubular body.

The second removable cap is substantially disk shaped with a circumferential groove. The second tubular body has an outwardly extending circumferential feature near the second end. The circumferential groove engages with the outwardly extending circumferential feature when the second removable cap is coupled to the second tubular body.

The segmented container also includes: a first strap coupled between the first removable cap and the first tubular body; and a second strap coupled between the second removable cap and the second tubular body.

The first strap, the first removable cap, the first bottom, and the first tubular body are molded in a first unitary piece. The second strap, the second removable cap, the second bottom, and the second tubular body are molded in a second unitary piece.

The magnet is coupled to the first bottom by an adhesive. The ferromagnetic piece is coupled to the second bottom with the adhesive.

The first and second bottoms each include a retaining feature on an outside surface of the first and second bottoms. The magnet is inserted into the retaining feature of the first bottom. The ferromagnetic piece is inserted into the retaining feature of the second bottom.

The magnet is molded within the first bottom. The ferromagnetic piece is molded within the second bottom.

The first bottom and the first tubular body are molded in a first piece with the circumferential groove molded therein. The second bottom, the protruding ring and the second tubular body are molded in a second piece.

The segmented container also includes: a magnet disposed in the first bottom; and a ferromagnetic piece disposed in the second bottom.

According to some embodiments, a method to manufacture a segmented container includes: injection molding a first container having: a first cylindrical body, a first bottom coupled to a first end of the first cylindrical body, a first cap, and a first strap coupling the first cap to the first cylindrical body; and injection molding a second container having: a second cylindrical body, a second bottom coupled to a first end of the second cylindrical body, a second cap, and a second strap coupling the second cap to the second cylindrical body. The first cap snap fits onto the second end of the first cylindrical body.

The second cap snap fits onto the second end of the second cylindrical body. The first bottom has a magnet coupled thereto. The second bottom has a ferromagnetic piece coupled thereto.

The method further includes, in some embodiments, inserting the magnet into a recess formed in the first bottom; and inserting the ferromagnetic piece into a recess formed in the second bottom. In other embodiments, the method includes affixing the magnet to an outer surface of the first bottom via an adhesive; and affixing the ferromagnetic piece to an outer surface of the second bottom via the adhesive.

In even other embodiments, the injection molding of the first container includes overmolding a magnet into the first bottom. The injection molding of the second container includes overmolding a ferromagnetic piece into the second bottom.

Also disclosed is a segmented container with: a first container having a first cylindrical body, a first bottom coupled to a first end of the first cylindrical body, and a first cap selectively couplable to a second end of the first cylindrical body; a second container having a first cylindrical body, a second bottom coupled to a first end of the second cylindrical body, and a second cap selectively couplable to a second end of the second cylindrical body; a magnet coupled to the first bottom; and a ferromagnetic piece coupled to the second bottom.

A first strap is coupled between the first cylindrical body and the first cap; and a second strap is coupled between the second cylindrical body and the second cap.

Both the magnet and the ferromagnetic piece are adhered to the first bottom and the second bottom, respectively by an adhesive or an epoxy.

The first bottom has a first retaining feature. The second bottom has a second retaining feature. The magnet is placed into the first retaining feature. The ferromagnetic piece is placed into the second retaining feature.

The first bottom has a first circumferential extension that extends axially away from the first tubular body. The second bottom has a second circumferential extension that extends axially away from the second tubular body. An inner diameter of the first circumferential extension is slightly larger than the outer diameter of the second circumferential extension. The second circumferential extension slides into the first circumferential extension when the first container is coupled to the second container.

In yet another embodiment, a segmented container is disclosed that includes: a first container having a first tubular body, a first bottom coupled to a first end of the first tubular body, and a first removable cap selectively couplable to a second end of the first tubular body; and a second container having a first tubular body, a second bottom coupled to a first end of the second tubular body, and a second removable cap selectively couplable to a second end of the second tubular body. The first removable cap snap fits onto the second end of the first tubular body. The second removable cap snap fits onto the second end of the second tubular body. The first bottom has a linear ridge formed thereon. The second bottom has a linear groove defined therein. The ridge of the first bottom is adapted to engage with the linear groove of the second bottom.

Either the groove of the second bottom or the ridge of the first bottom has a raised bump. The other of the groove of the second bottom and the ridge of the first bottom has a recess. The bump engages with the recess when the first container is coupled to the second container.

The linear groove has a raised bump centrally located on the linear groove.

The linear ridge has a recess centrally located on the linear ridge. The bump engages with the recess.

A cross section of the linear groove is a quadrilateral.

A cross section of the linear groove is an isosceles trapezoid in which two of the angles are obtuse and two of the angles are acute; and

the two acute angles are located closer to the second tubular body than the two obtuse angles.

A cross section of the ridge is an isosceles trapezoid with two obtuse angles and two acute angles. The two acute angles are located closer to the first tubular body than the two obtuse angles.

centerline of the linear groove is contiguous with a diametral plane of the first cylinder.

The linear groove has a first end and a second end. Chamfers are provided on both sides of the first end of the linear groove; and chamfers are provided on both sides of the second end of the linear groove.

The linear groove has a raised recess centrally located on the linear groove. The linear ridge has a bump centrally located on the linear ridge. The bump engages with the recess when the first container is coupled with the second container.

According to some embodiments, a method to manufacture a segmented container includes: injection molding a first container having: a first tubular body, a first bottom coupled to a first end of the first tubular body, a first cap, and a first strap coupling the first cap to the first tubular body; and injection molding a second container having: a second tubular body, a second bottom coupled to a first end of the second tubular body, a second cap, and a second strap coupling the second cap to the second tubular body. The first bottom has a linear groove defined therein. The second bottom has a linear ridge formed thereon. The linear ridge of the second bottom is adapted to engage with the linear groove of the first bottom. An opening of the linear groove is narrower than a portion of the linear groove nearer the first tubular body.

The linear groove has a raised bump centrally located on the linear groove. The linear ridge has a recess centrally located on the linear ridge. The bump engages with the recess.

A cross section of the linear groove is polygonal, in some embodiments a quadrilateral. In some embodiments, the cross section of the linear groove is an isosceles trapezoid in which two of the angles are obtuse and two of the angles are acute; and the two acute angles are located closer to the first tubular body than the two obtuse angles.

A centerline of the linear groove is contiguous with a diametral plane of the first tubular body.

The linear groove has a first end and a second end. Material surrounding the first end of the linear groove is chamfered. Material surrounding the second end of the linear groove is chamfered.

The first and second tubular bodies are cylindrical. In other embodiments, the bodies are frustums. Alternatively, any suitable shape is molded.

In some embodiments, a segmented container is disclosed that has: a first container having a first tubular body, a first bottom coupled to a first end of the first tubular body, and a first removable cap selectively couplable to a second end of the first tubular body; and a second container having a first tubular body, a second bottom coupled to a first end of the second tubular body, and a second removable cap selectively couplable to a second end of the second tubular body. The first removable cap snap fits onto the second end of the first tubular body. The second removable cap snap fits onto the second end of the second tubular body. The first bottom has a linear groove defined therein. The second bottom has a linear ridge formed thereon. The linear ridge of the second bottom is adapted to engage with the linear groove of the first bottom. An opening of the linear groove is narrower than a portion of the linear groove nearer the first tubular body.

The ridge extends outwardly from the second bottom. A portion of the ridge that is nearest to the second tubular body is narrower than a portion of the ridge that farthest from the second tubular body.

The first removable cap is substantially disk shaped with a circumferential groove. The first tubular body has an outwardly extending circumferential feature near the second end. The circumferential groove engages with the outwardly extending circumferential feature when the first removable cap is coupled to the first tubular body. The second removable cap is substantially disk shaped with a circumferential groove. The second tubular body has an inwardly extending circumferential ridge near the second end. The circumferential groove engages with the outwardly extending circumferential feature when the second removable cap is coupled to the second tubular body. A first strap couples the first removable cap to the first tubular body; and a second strap couples the second removable cap to the second tubular body.

### BRIEF DESCRIPTION OF THE DRAWINGS

FIG. 1 is a prior art, air-tight protective container;

FIG. 2 is a segmented container having two coupled containers with the caps of the two containers uncoupled to their respective tubes;

FIG. 3 shows the segmented container of FIG. 2 with the two containers decoupled and the caps coupled to their respective tubes;

FIGS. 4 and 5 show a portion of one of the segmented containers of FIGS. 2 and 3 in cross section;

FIG. 6 is a blow up of the central section of the segmented container of FIG. 4 showing the central coupling section;

FIG. 7 shows a portion of a segmented container having two decoupled containers in cross section;

FIG. 8 shows the segmented container of FIG. 6 in cross section with the two containers coupled;

FIG. 9 is a cross-sectional view of a portion of one of the two segments for a segmented container having a magnet;

FIG. 10 is a portion of a segmented container having two containers; and

FIG. 11 shows the segmented container of FIG. 10 shown in cross section and with the two containers coupled.

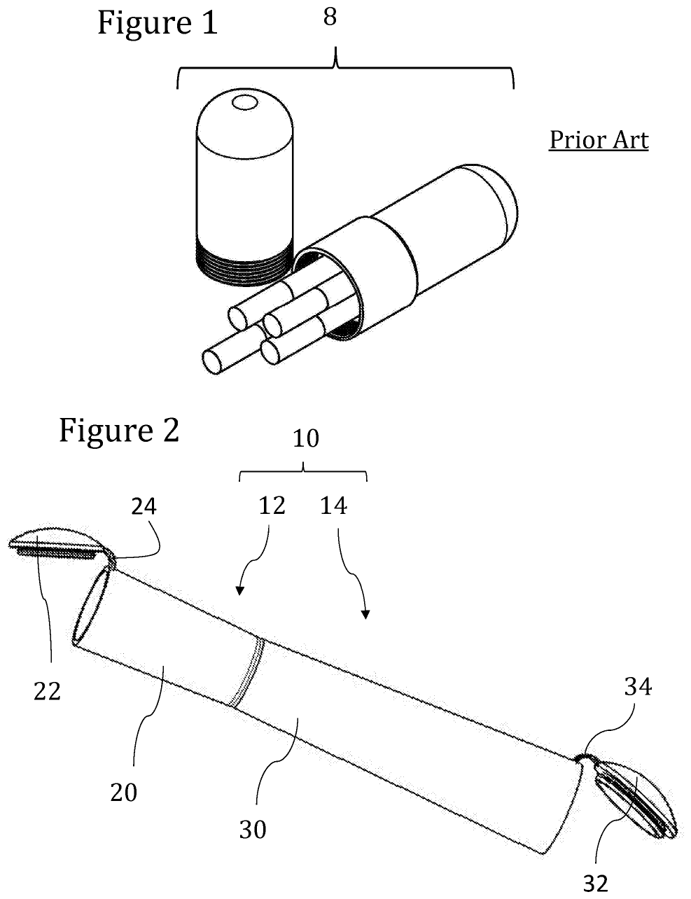

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

A segmented container 10 that has a first container 12 and a second container 14 is shown with the containers 12 and 14 coupled in FIG. 2. Containers 12 and 14 have tubular bodies 20 and 30, respectively. In a non-limiting example, tubes 20 and 30 are frustums, which are defined as “the portion of a cone or pyramid which remains after its upper part has been cut off.” This is one non-limiting example. Alternatively, the tubular bodies can be standard cylinders or any other suitable geometry. Furthermore, the tubular bodies can be any decorative or artful geometry. Container 14 is longer than container 12 in FIG. 2, possibly for a fresh cigarette to be held in container 14 and a partially consumed cigarette in container 12. In the case of medications, containers 12 and 14 might be considerably shorter, although in some embodiments, also different in length with the primary supply in container 30 and the temporary supply in container 20. In other embodiments, the containers are of the same length.

Each of containers 12 and 14 have a lid, 22 and 32, respectively. A strap 24 is provided between tubular body 20 and lid 22. A strap 34 is also provided between tubular body 30 and lid 32. An advantage of the strap is to keep the cap with its respective container.

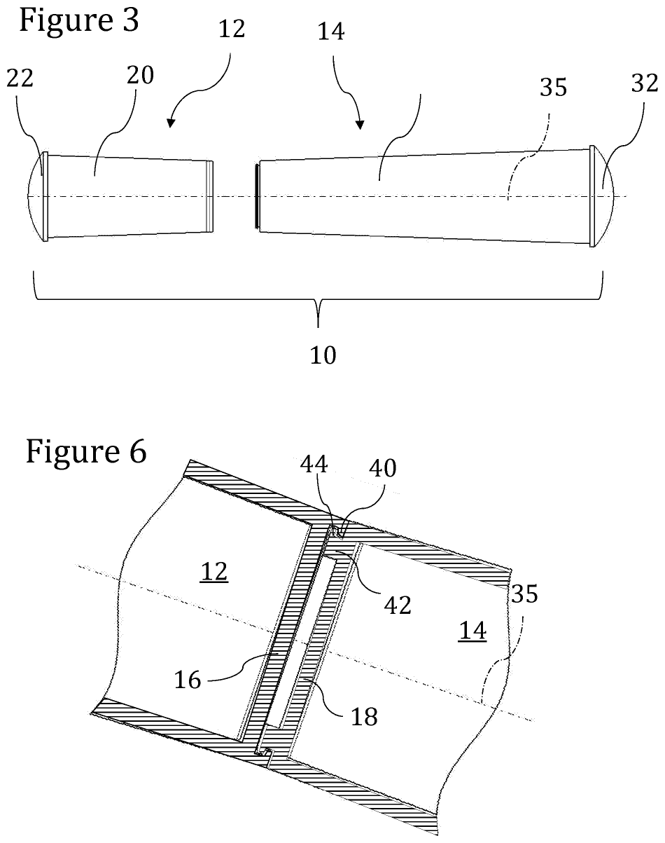

In FIG. 2, first and second containers 12 and 14 are shown coupled. In FIG. 3, containers 12 and 14 are shown with caps 22 and 32 coupled to tubular bodies 20 and 30, respectively. FIG. 3 shows containers 12 and 14 decoupled. A centerline 35 of containers 12 and 14 is shown as a dash-dot line.

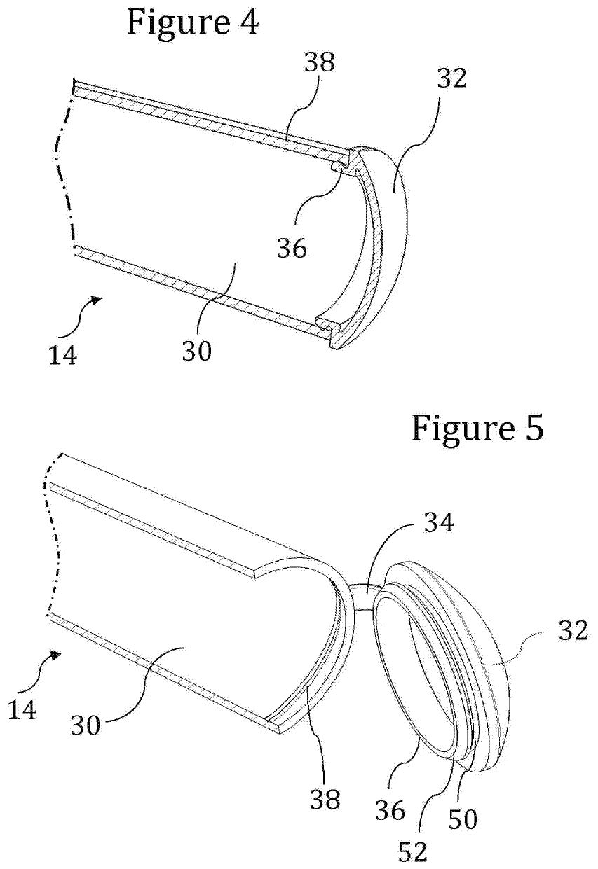

In FIG. 4, a portion of second container 14 is shown. Cap 32 is shown engaged with an end of tubular body 30. Cap 32 has an extension 36 that extends into the inside of tubular body 30. Referring now to FIG. 5, a portion of second container 14 is shown in which cap 32 is disengaged from tubular body 30. Tubular body 30 has a circumferential groove 38 that is defined on an inner surface of tubular body 30. Cap 32 is attached to tubular body 30 via strap 34. Extension 36 of cap 32, has a circumferential groove 50 and a tab 52 that extends outwardly in a radial direction from extension 36. When cap 32 engages with tubular body 30, tab 52 engages with groove 38.

In FIG. 6, a portion of containers 12 and 14 are shown in cross section.

Container 12 has a bottom 16 that has an extension 40 that extends outwardly in an axial direction. Extension 40 has a circumferential groove that faces inwardly. (The groove is not separately called out in FIG. 6 as it is filled with a tab discussed immediately below in regard to container 14.) Container 14 has a bottom 18 that an extension 42 that extends outwardly from container 14 in an axial direction. Extension 42 has a circumferential tab 44 that extends away from extension 42 in an outwardly radial direction. Containers 12 and 14 are shown coupled in FIG. 6. Tab 44 of extension 42 of container 14 engages with the groove formed in extension 40 of container 12.

In an alternative embodiment, a segmented container 60 has a first container 62 that couples with a second container 64 via a magnetic connection, such as shown in cross section in FIG. 7. A portion of first tubular body 66 has a first bottom 70. First bottom 70 has a first axial extension 74 that extends away from first tubular body 66. Second container 64 has a second tubular body 68 has a second bottom 72. Second bottom 72 that has a second axial extension 76 that extends away from second tubular body 64. A magnet 80 is adhered to first bottom 70. A ferromagnetic piece 82, i.e., a piece made out of a material that is attracted by magnets, is adhered to second bottom 72. Magnet 80 and ferromagnetic piece 82 are adhered to bottoms 70 and 72, respectively, by any kind of suitable glue, epoxy, or adhesive material.

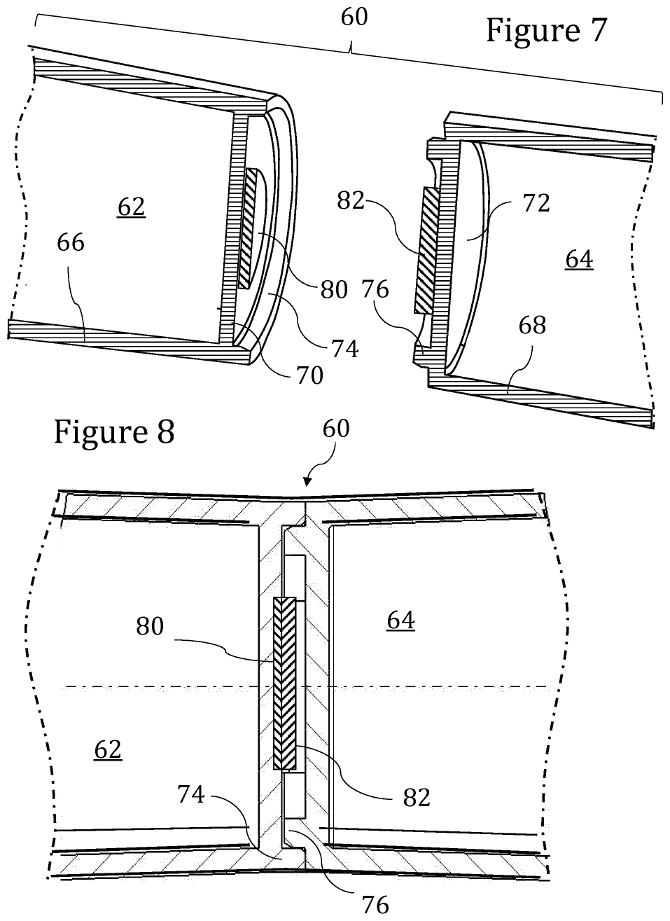

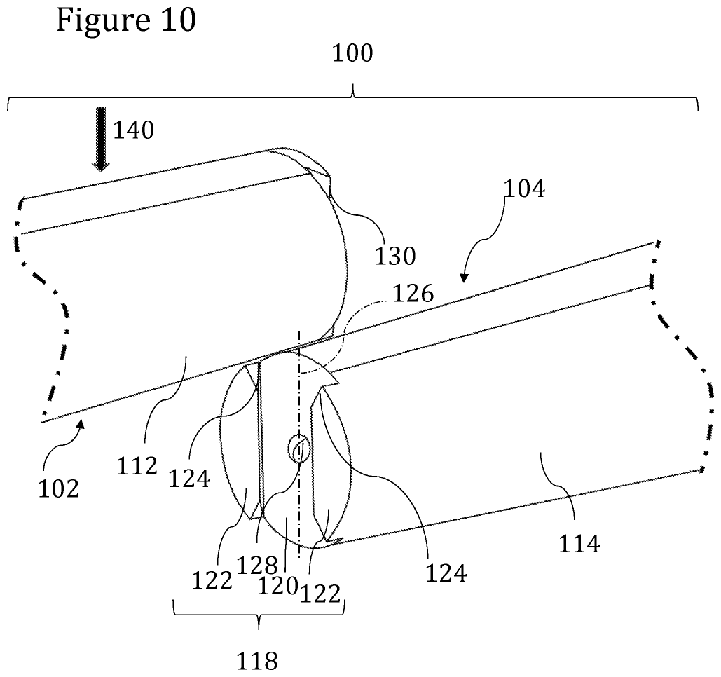

First and second axial extensions 74 and 76, respectively, are made to nest. An outer diameter of second axial extension 76 is slightly smaller than an inner diameter of first axial extension 74 so that when magnet 80 pulls on ferromagnetic piece 82, the extension 74 and 76 move past each other so that 80 and 82 abut each other, or very nearly abut each other. FIG. 8 shows a cross-sectional view showing first container 62 coupled with second container 64 coupled via magnetic attraction. An advantage of axial extensions 74 and 76 is in aligning containers 62 and 64. Once coupled, they help to prevent containers 62 and 64 from sliding apart in a direction perpendicular to a central axis 84 that goes through a centerline of containers 62 and 64. An advantage of such an embodiment in FIGS. 7 and 8 is that if containers 80 and 82 were to decouple in one's pocket, for example, they are likely to recouple when they are again in mutual proximity.

The example in FIGS. 7 and 8 show magnet 80 and first axial extension 74, i.e. the axial extension, of 74 and 76 to have a larger diameter, associated with first container 62. However, that is one non-limiting example. First container 62 could, in other embodiments, include one or both of ferromagnetic piece 82 and an axial extension like second axial extension 76 that is smaller in diameter with the corresponding parts provided on second container 64. In even other embodiments, axial extensions, 74 and 76, are not provided at all with the magnet and ferromagnetic piece serving as the sole coupler.

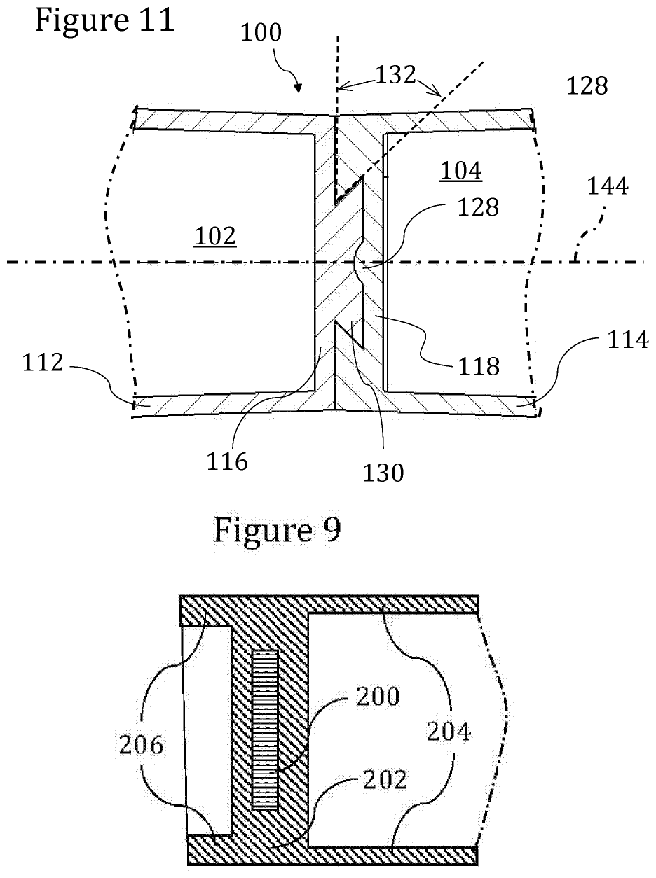

The embodiments discussed immediately above include a magnet that is adhered to the bottom of one of the tubes. In an alternate embodiment, shown in FIG. 9, a magnet 200 is placed in the injection molding die before the plastic is injected into the die, commonly called insert molding. The tube 204, of which only a portion is shown has a bottom 202 integrally formed, as well as an axial extension 206 that extends outwardly from bottom 202. Axial extension 206 is analogous to axial extension 74 of first tubular body 66 that engages with axial extension 76 of second tubular body 68, elements 74, 66, 76, and 68 being shown in FIG. 7. FIG. 9 shows only a portion of one of the segmented containers. A second container (not shown) would include an axial extension analogous to axial extension 76 of FIG. 7 that would engage with axial extension 206. The second container would include a ferromagnetic piece that would be attracted to magnet 200. The ferromagnetic piece could be overmolded, i.e., contained within the bottom of the second container or glued to the surface of the bottom of the second container.

In yet another embodiment in FIG. 10, a segmented container 100 includes a first container 102 having a first tubular body 112 and a second container 104 having a second tubular body 114. Only a portion of tubular bodies 112 and 114 are shown in FIG. 10. First tubular body 112 has a bottom 116 (not visible in FIG. 10) that includes a ridge 130. Second tubular body 114 has a second bottom 118 that has a groove 120 provided between two lands 122. Chamfers 124 are provided on each end of lands 122. Segmented container 100 is shown decoupled in FIG. 10. To couple first container 102 with second container 104, first container 102 is slid downward, as illustrated by arrow 140, with respect to second container 104. Chamfers 124 help to guide ridge 130 into alignment. A bump 128 is provided on second bottom 118.

In FIG. 11, a portion of segmented container 100 is shown as coupled with a centerline 144. Ridge 130 has acute angles 132 between first bottom 116 and ridge 130 so that when installed in groove 120 (not visible as a groove in FIG. 11 as ridge 130 is within groove 120) first container 102 does not decouple from second container 104 in an axial direction. Ridge 130 also has a cup defined therein into which bump 128 meshes. (The cup defined in ridge 130 is not separately called out with a numeral as it is filled with bump 128 in FIG. 11.) Bump 128 and the corresponding cup are provided to deter uncoupling of the containers. That is, it takes some force to decouple first container 102 from second container 104 so that it is only decoupled as desired by the user as opposed to an undesired decoupling while being stowed in a pocket, purse, backpack, etc. Alternatively, the ridge is provided with a bump and the groove has a recess defined therein to accept the bump when first container 102 is coupled with second container 104. Groove 120 and ridge 130 are reminiscent of a dovetail joint.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, efficiency, strength, durability, life cycle cost, marketability, appearance, packaging, size, serviceability, weight, manufacturability, ease of, etc. The embodiments described herein that are characterized as less desirable than other embodiments or prior art implementations with respect to one or more characteristics are not outside the scope of the disclosure and may be desirable for particular applications.

We claim:

1. A segmented container, comprising:
a first container having a first tubular body, a first bottom coupled to a first end of the first tubular body, and a first removable cap selectively couplable to a second end of the first tubular body; and
a second container having a first tubular body, a second bottom coupled to a first end of the second tubular body, and a second removable cap selectively couplable to a second end of the second tubular body, wherein:
the first removable cap snap fits onto the second end of the first tubular body;
the second removable cap snap fits onto the second end of the second tubular body;
the first bottom has a linear ridge formed thereon;
the second bottom has a linear groove defined therein; and
the ridge of the first bottom is adapted to engage with the linear groove of the second bottom.

2. The segmented container of claim 1, wherein:
one of the groove of the second bottom and the ridge of the first bottom has a raised bump;
the other of the groove of the second bottom and the ridge of the first bottom has a recess; and
the bump engages with the recess when the first container is coupled to the second container.

3. The segmented container of claim 1, wherein a cross section of the linear groove is a quadrilateral.

4. The segmented container of claim 1, wherein:
a cross section of the linear groove is an isosceles trapezoid in which two of the angles are obtuse and two of the angles are acute; and
the two acute angles are located closer to the second tubular body than the two obtuse angles.

5. The segmented container of claim 1, wherein:
a cross section of the ridge is an isosceles trapezoid with two obtuse angles and two acute angles; and
the two acute angles are located closer to the first tubular body than the two obtuse angles.

6. The segmented container of claim 1, wherein:
the linear groove has a first end and a second end;
chamfers are provided on both sides of the first end of the linear groove; and
chamfers are provided on both sides of the second end of the linear groove.

7. The segmented container of claim 1, wherein:
the linear groove has a raised recess centrally located on the linear groove;
the linear ridge has a bump centrally located on the linear ridge; and
the bump engages with the recess when the first container is coupled with the second container.

8. A method to manufacture a segmented container, comprising:
injection molding a first container having: a first tubular body, a first bottom coupled to a first end of the first tubular body, a first cap, and a first strap coupling the first cap to the first tubular body; and
injection molding a second container having: a second tubular body, a second bottom coupled to a first end of the second tubular body, a second cap, and a second strap coupling the second cap to the second tubular body, wherein:
the first bottom has a linear groove defined therein;
the second bottom has a linear ridge formed thereon;
the linear ridge of the second bottom is adapted to engage with the linear groove of the first bottom; and
an opening of the linear groove is narrower than a portion of the linear groove nearer the first tubular body.

9. The method of claim 8, wherein:
the linear groove has a raised bump centrally located on the linear groove;
the linear ridge has a recess centrally located on the linear ridge; and
the bump engages with the recess.

10. The method of claim 8, wherein a cross section of the linear groove is polygonal.

11. The method of claim 8, wherein the cross section of the linear groove is a quadrilateral.

12. The method of claim 8, wherein:
the cross section of the linear groove is an isosceles trapezoid in which two of the angles are obtuse and two of the angles are acute; and
the two acute angles are located closer to the first tubular body than the two obtuse angles.

13. The method of claim 8, wherein a centerline of the linear groove is contiguous with a diametral plane of the first tubular body.

14. The method of claim 8, wherein:
the linear groove has a first end and a second end;
material surrounding the first end of the linear groove is chamfered; and
material surrounding the second end of the linear groove is chamfered.

15. The method of claim 8, wherein:
the first tubular body is one of: a cylinder and a frustum; and
the second tubular body is one of: a cylinder and frustrum.

16. A segmented container, comprising:
a first container having a first tubular body, a first bottom coupled to a first end of the first tubular body, and a first removable cap selectively couplable to a second end of the first tubular body; and
a second container having a first tubular body, a second bottom coupled to a first end of the second tubular body, and a second removable cap selectively couplable to a second end of the second tubular body, wherein:
the first removable cap snap fits onto the second end of the first tubular body;
the second removable cap snap fits onto the second end of the second tubular body;
the first bottom has a linear groove defined therein;
the second bottom has a linear ridge formed thereon;
the linear ridge of the second bottom is adapted to engage with the linear groove of the first bottom; and
an opening of the linear groove is narrower than a portion of the linear groove nearer the first tubular body.

17. The segmented container of claim 16, wherein:
the ridge extends outwardly from the second bottom; and
a portion of the ridge that is nearest to the second tubular body is narrower than a portion of the ridge that farthest from the second tubular body.

18. The segmented container of claim 16, wherein:
the first removable cap is substantially disk shaped with a circumferential groove;
the first tubular body has an outwardly extending circumferential feature near the second end; and
the circumferential groove engages with the outwardly extending circumferential feature when the first removable cap is coupled to the first tubular body.

19. The segmented container of claim 16, wherein:
the second removable cap is substantially disk shaped with a circumferential groove;
the second tubular body has an inwardly extending circumferential ridge near the second end;
the circumferential groove engages with the outwardly extending circumferential feature when the second removable cap is coupled to the second tubular body;
a first strap couples the first removable cap to the first tubular body; and
a second strap couples the second removable cap to the second tubular body.

20. The segmented container of claim 16, wherein:
the first tubular body is one of: a cylinder and a frustum; and
the second tubular body is one of: a cylinder and frustrum.
